(19) United States
(12) Patent Application Publication
(10) Pub. No.: US 2005/0044048 A1
(43) Pub. Date: Feb. 24, 2005

(54) Access control apparatus, systems, and methods

(75) Inventors: Krystof C. Zmudzinski, Forest Grove, OR (US); Jason A. Domer, Banks, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/645,127

(22) Filed: Aug. 21, 2003

(51) Int. Cl. G06F 17/60

(52) U.S. Cl. 705/59

(57) ABSTRACT

An apparatus and a system, as well as a method and article, may operate to enable execution of a first application on a master device by allocating a master license and at least one shareable license to the master device, and to enable execution of a second application (which may be the same as the first application) on a shareable device by executing the first application on the master device and by allocating the at least one shareable license to the shareable device.

### TECHNICAL FIELD

Various embodiments described herein relate to data processing generally, including apparatus, systems, and methods used to control access to, and use of, application programs.

### BACKGROUND INFORMATION

Gaming as a type of recreation has become so popular with consumers that even purportedly utilitarian devices, such as personal digital assistants (PDAs) and cellular telephones, are now provided with built-in games. Multi-player games, where people can enjoy interacting with others on various levels, are growing in importance, as evidenced by the proliferation of dedicated gaming devices, including gaming consoles that interface to television sets and wide area networks.

Thus, many consumers find multiplayer games, with the challenge of competing against live opponents, to be more exciting than single player games. However, multi-player games used in conjunction with the utilitarian devices mentioned above, are not common. Perhaps this is because some gaming industry revenue models provide free sharing of multiplayer game content, while others do not allow content sharing at all. New revenue models that lie between these two extremes, allowing end-users to share rights in content, such as multi-player games, while producing additional revenue, might be a welcome addition to the industry.

### BRIEF DESCRIPTION OF THE DRAWINGS

FIG. 1 is a block diagram of apparatus and systems according to various embodiments;

FIG. 2 is a flow chart illustrating several methods according to various embodiments; and

FIG. 3 is a block diagram of an article according to various embodiments.

### DETAILED DESCRIPTION

The controlled content sharing model (CCSM) described herein is an approach to the control of shared content which permits end-users to share rights in the same content, including applications such as a multi-player games, while producing additional revenue for the content provider. The essence of the idea lies in limited sharing of content between a master licensee (or master device) and one or more shareable licensees (or shared devices).

A “master license” for the purposes of this document may include any code, structure, or form of permission that permits an apparatus (i.e., a master device) to freely execute a selected application. A “shareable license” for the purposes of this document may include any code, structure, or form of permission that is activated, issued, or transmitted to another device (i.e., a shareable device) by the master device that permits the shareable device to execute an application (which may be the same as the selected application). That is, the master device granting permission to execute the application on the shareable device must also have a master license associated with the selected application.

CCSM operation may be illustrated by a simple example. Consider a master licensee purchasing a multi-player game to be played over a Personal Area Network (PAN). Of course, the multi-player game or other licensed application could also be used in conjunction with any type of network (e.g., wide area network, local area network), including a PAN. Assume that the master licensee is issued one master license and four shareable licenses that are associated with the master license granted to the master licensee, and to no other entity. In addition, assume that a master copy of the game, which may be downloaded over a Wide Area Network (WAN), is configured to execute on a single mobile phone associated with the master licensee.

In this exemplary scenario, it may be imagined that the master licensee has some way to share a version of the game with as many other users as he likes, but he may only allocate shareable licenses to four users (i.e., shareable licensees) at one time. The games shared with the shareable licensees may operate only in the context of a multiplayer game session initiated by the master licensee. Any one or all of the allocated and issued shareable licenses may be revoked at will by the master licensee, or when the master licensee ceases to execute the shared application, or whenever any one of the shareable licensees chooses to terminate execution of his shareable application (e.g., when a shareable licensee chooses to leave the multiplayer game session, the shareable license associated with his gaming device may be revoked). Users having shareable versions of the application may be given the opportunity to upgrade to a master license for a fee, and thus enjoy the same privileges as the master user, including the ability to procure some selected number of shareable licenses.

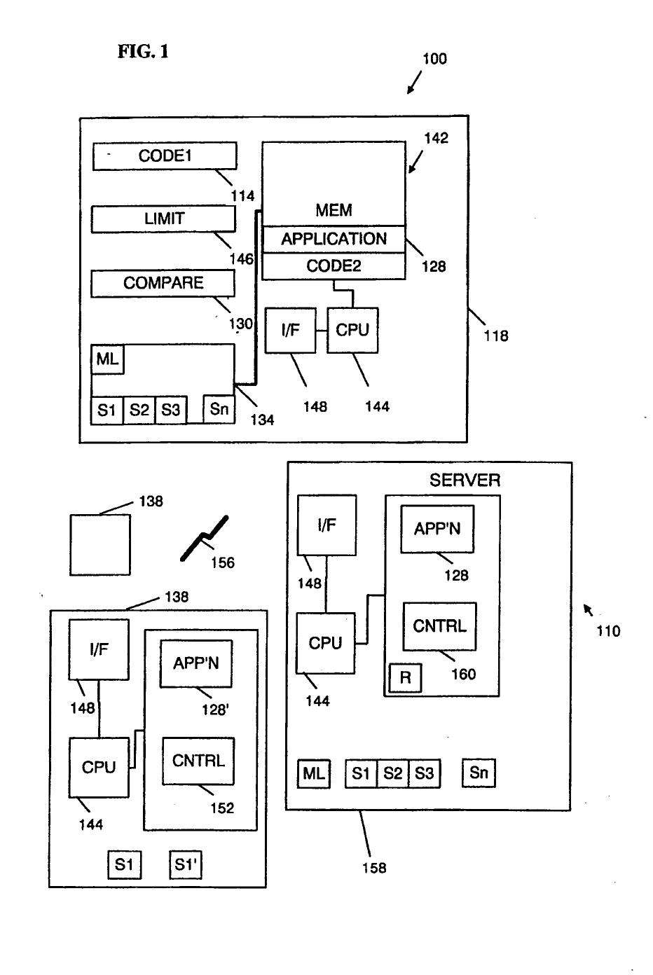

FIG. 1 is a block diagram of apparatus 100, 138 and systems 110 according to various embodiments, each of which may operate in the manner described above. For example, an apparatus 100, which may comprise a cellular telephone, a laptop or palmtop computer, a device having an embedded microprocessor, a video display terminal, a PDA, or any type of device (mobile or stationary) capable of executing a set of programmed instructions, may have a first memory 114 included in a master device 118 to store a first code CODE1. The first memory 114 may be a one-time programmable memory.

The first code CODE1 may be used to check or be compared against a second code CODE2 included in a selected application 128. A positive comparison between the first and the second codes CODE1, CODE2 may enable execution of the application 128 on the master device 118. Thus, a comparison module 130 may be included in the master device 118 to compare the first and second codes CODE1, CODE2.

The apparatus 100 may also include a second memory 134 (which may be included in the master device 118) to store one or more shareable codes S1, S2, S3, . . . Sn that are allocatable to one or more corresponding apparatus 138, including shareable devices, enabling execution of the application (or an associated application) 128′ on each apparatus 138.

In an embodiment, an apparatus 100, including any type of device (mobile or stationary) capable of executing a set of programmed instructions, may also comprise a memory 142 to store an application 128, a master license ML, and a plurality of shareable licenses S1, S2, S3, . . . , Sn. The apparatus 100 may also include a processor 144, which may be coupled to the memory 142, to execute the application 128. A wireless interface 148, perhaps coupled to the processor 144, may be included in the apparatus 100 and used to transmit the application 128 and a shareable license (e.g., one of the shareable licenses S1, S2, S3, . . . , Sn) included in the plurality of shareable licenses to an apparatus 138, including a shareable device, which may comprise a wireless apparatus. The apparatus 100 may include a module 146 to limit the plurality of shareable licenses S1, S2, S3, . . . , Sn to a selected number.

In some embodiments, the apparatus 100 may include an application 128 comprising a second code CODE2. As mentioned above, the apparatus 100 may further include a one-time programmable memory 114 to store a first code CODE1, as well as a comparison module 130 to compare the first code CODE1 with the second code CODE2. The processor 144 may be allowed to execute the application 128 only if the first code CODE1 matches the second code CODE2. In some embodiments, the first code CODE1 may comprise a gate-keeper code.

Other embodiments may be realized. For example, an apparatus 138, including a shareable device, may comprise a control module 152 coupled to a wireless interface 148 and a processor 144. The control module 152 may be used to receive an authorization 156 from a wireless apparatus 100 (e.g., a master device). The processor 144 may be used to execute an application 128′ included in the apparatus 138 if and only if the authorization 156 is received by the control module 152. It should be noted that the application 128′ may be the same as the application 128, associated with the application 128, or different than the application 128.

The authorization 156 may comprise a shareable license S1, which may emanate from an apparatus 100, including a wireless apparatus having a master license (e.g., a master device 118). The shareable license S1 may be one of a selected number of shareable licenses (e.g., S1, S2, S3, . . . , Sn) allocated to the wireless apparatus 100. The authorization 156 may also comprise a code S1′ associated with the shareable license S1. The shareable license S1 and/or the code S1′ may be stored in the apparatus 138. The application 128 may comprise a game.

In another embodiment, a system 110, including any device or group of devices capable of executing a set of programmed instructions, may comprise one or more apparatus 100 as described above, as well as a content server 158 having an application 128 associated with a master code ML included in an apparatus 100, perhaps comprising a master device 118. The system 110 and the content server 158 may also include a selected number of shareable codes S1, S2, S3, . . . , Sn to enable concurrent execution of the application 128 on the apparatus 100 and a number of other apparatus 138, including shareable devices, up to the selected number. The system 110 may also include a processor 144 and/or a wireless interface 148 coupled to the content server 158.

The apparatus 100 may be used to receive the application 128 and the master code ML from the content server 158. As noted above, the apparatus 100, which may comprise a master device 118, may include a wireless communication device, such as a PDA, or a cellular telephone.

In an embodiment, a server 158 may comprise a control module 160 coupled to a wireless interface 148 to communicate with an apparatus 100, including a wireless apparatus. The control module 160 may be used to evaluate a request R from the apparatus 100 (e.g., a request R to download an application 128, including a shareable application), and to transmit the application 128 to the apparatus 100, along with a master license ML and one or more shareable licenses S1, S2, S3, . . . Sn. As noted above, the application 128 may comprise a game, including a multi-player game.

The codes CODE1, CODE2, and S1′, master license ML, shareable licenses S1, S2, S3, . . . , Sn, apparatus 100, system 110, memory 114, master device 118, applications 128, 128′, comparison module 130, memory 134, apparatus 138, memory 142, processors 144, wireless interfaces 148, control module 152, authorization 156, content server 158, and control module 160 may all be characterized as “modules” herein. Such modules may include hardware circuitry, and/or one or more processors and/or memory circuits, software program modules, including objects and collections of objects, and/or firmware, and combinations thereof, as desired by the architect of the apparatus 100, 138 and the system 110, and as appropriate for particular implementations of various embodiments.

It should also be understood that the apparatus and systems of various embodiments can be implemented with respect to applications other than games, and other than for apparatus and systems that include a plurality of cellular telephones or PDAs, and thus, various embodiments are not to be so limited. The illustrations of various apparatus 100, 138 and systems 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, and application-specific modules, including multilayer, multi-chip modules. Such apparatus and systems may further be included as sub-components within a variety of electronic systems, such as televisions, personal computers, dedicated gaming consoles, laptop computers, workstations, radios, video players, vehicles, and others.

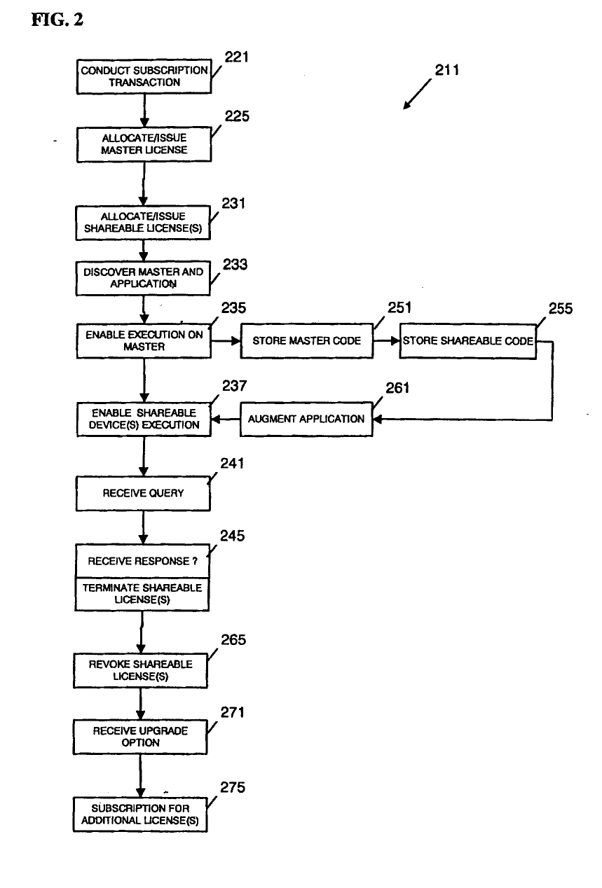

FIG. 2 is a flow chart illustrating several methods according to various embodiments. A method 211 may (optionally) begin with conducting a subscription transaction associated with a master license and an associated application prior to allocating and issuing the master license at block 221. The method 211 may then continue with issuing a master license to a master device at block 225. The master license may be associated with any application, including but not limited to a gaming application, a music application (e.g., interactive multimedia or a group of musicians playing in a band), etc. The method 211 may also include allocating and issuing a plurality of shareable licenses associated with the same application to the master device at block 231. At this point, the method 211 may include discovering the existence of the master device and the application by the shareable device, and receiving the application (or an associated application) by the shareable device at block 233.

The method 211 may also include enabling execution of the application (e.g., a first application) on the master device at block 235, which may occur when a master license and at least one shareable license are allocated or issued to the master device, and enabling execution of a the same application (or an associated application, e.g., a second application) on one or more shareable devices at block 237, perhaps by executing the first application on the master device and by allocating and/or issuing a shareable license to each shareable device. Thus, the method 211 may include allocating and issuing a plurality of shareable licenses to the master device, and allocating and issuing one or more of the plurality of shareable licenses to a corresponding plurality of shareable devices. The method 211 may also include enabling execution of an application on a master device by allocating a master license and at least one shareable license to the master device, as well as enabling execution of the application on a shareable device for a selected time period by allocating a shareable license to the shareable device. Thus, issuing the plurality of shareable licenses associated with the application to the master device may include sending information to the master device, enabling the master device to control execution of the application on a number of shareable devices corresponding to the plurality of shareable licenses.

It should be noted that “allocating” licenses includes the activity of setting aside or reserving licenses for selected master devices and/or shareable devices. “Issuing” licenses includes the activity of communicating licenses to master devices and shareable devices such that a device receiving the communication becomes a master device or shareable device, respectively, as defined above.

The method 211 may continue with receiving a query at the master device to determine current execution of the first application at block 241, that is, whether the first application is currently executing on the master device. The method 211 may also include receiving a response at the shareable device (e.g., from the master device) to verify the current execution of the first application at block 245. If no response is received, the second application, executing on the shareable device, may be terminated. Thus, the method 211 may include terminating the execution of the second application on one or more shareable devices after failing to receive a response verifying current execution of the first application on the master device at block 245.

Enabling execution of the application on the master device at block 235 may further include storing a master license code (e.g., CODE2 described above) associated with the master license (e.g., ML described above) in the master device at block 251. Enabling execution of the application on the master device at block 235 may also include storing a shareable license code (e.g., S1′ described above) associated with the shareable license (e.g., S1 described above) in the shareable device at block 255. Enabling execution of the application on the master device at block 235 may further include augmenting the application to include an application code (e.g., CODE2 described above) to check against a master license code (e.g., CODE1 described above) stored in the master device at block 261. As noted above, the grant or issue of a shareable license may be terminated at will, and thus the method 211 may include terminating execution of the application on one or more shareable devices by revoking the shareable license(s) at block 265.

The method 211 may include receiving an option to upgrade a shareable device to operate as a second master device at block 271. The method 211 may also include issuance of additional shareable licenses, and thus may include conducting a second subscription transaction associated with the master license and the application prior to allocating and issuing a second plurality of shareable licenses associated with the application to the master device at block 275.

It should be noted that the methods described herein do not have to be executed in the order described, or in any particular order. Moreover, various activities described with respect to the methods identified herein can be executed in serial or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as COBOL or C. The software components may communicate using any of a number of mechanisms well-known to those skilled in the art, such as application program interfaces or interprocess communication techniques, including remote procedure calls. The teachings of various embodiments of the present invention are not limited to any particular programming language or environment, including Hypertext Markup Language (HTML) and Extensible Markup Language (XML).

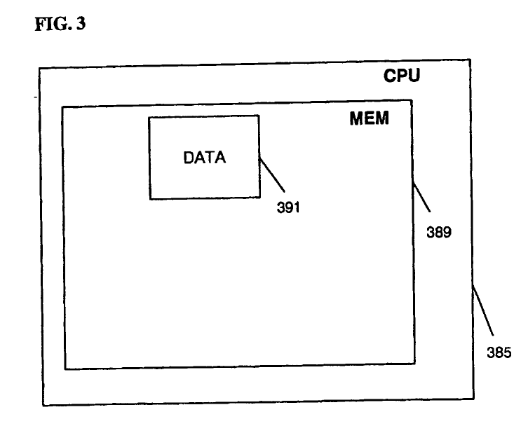

FIG. 3 is a block diagram of an article 385 according to various embodiments, such as a computer, a memory system, a magnetic or optical disk, some other storage device, and/or any type of electronic device or system. The article 385 may comprise a machine-accessible medium such as a memory 389 (e.g., a memory including an electrical, optical, or electromagnetic conductor) having associated data 391 (e.g., computer program instructions), which when accessed, results in a machine performing such actions as enabling execution of an application on a master device by allocating and/or issuing a master license and at least one shareable license to the master device, and enabling execution of the application on a shareable device for a selected time period by allocating and/or issuing the shareable license to the shareable device.

Enabling the execution of the application on the master device may further include storing a master license code associated with the master license in the master device, and storing a shareable license code associated with the shareable license in the shareable device. Enabling the execution of the application on the master device may also include augmenting the application to include an application code to check against a master license code stored in the master device. Other activities may include receiving an option to upgrade the shareable device to operate as a second master device, and/or terminating execution of the application on the shareable device by revoking its shareable license.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments of the invention. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

1. A method, comprising:
enabling execution of a first application on a master device by allocating a master license and at least one shareable license to the master device; and
enabling execution of a second application on a shareable device by executing the first application on the master device and by allocating the shareable license to the shareable device.

2. The method of claim 1, further comprising:
allocating a plurality of shareable licenses including the shareable license to the master device.

3. The method of claim 2, further comprising:
allocating the plurality of shareable licenses to a corresponding plurality of shareable devices.

4. The method of claim 1, further comprising:
receiving a query at the master device to determine current execution of the first application.

5. The method of claim 1, further comprising:
receiving a response at the shareable device to verify the current execution of the first application.

6. The method of claim 1, further comprising:
terminating the execution of the second application on the shareable device after failing to receive a response verifying current execution of the first application on the master device.

7. The method of claim 1, further comprising:
discovering the existence of the master device and the first application by the shareable device; and
receiving the second application by the shareable device.

8. An article comprising a machine-accessible medium having associated data, wherein the data, when accessed, results in a machine performing:
enabling execution of an application on a master device by allocating a master license and at least one shareable license to the master device; and
enabling execution of the application on a shareable device for a selected time period by allocating the shareable license to the shareable device.

9. The article of claim 8, wherein enabling the execution of the application on the master device further includes:
storing a master license code associated with the master license in the master device; and
storing a shareable license code associated with the shareable license in the shareable device.

10. The article of claim 8, wherein enabling the execution of the application on the master device further includes:
augmenting the application to include an application code to check against a master license code stored in the master device.

11. The article of claim 8, wherein the data, when accessed, results in the machine performing:
receiving an option to upgrade the shareable device to operate as a second master device.

12. The article of claim 8, wherein the data, when accessed, results in the machine performing:
terminating execution of the application on the shareable device by revoking the shareable license.

13. An apparatus, comprising:
a first memory included in a master device to store a first code to check against a second code included in an application, wherein a positive comparison between the first and the second codes enables execution of the application on the master device; and
a second memory included in the master device to store a shareable code allocatable to a shareable device to enable execution of the application on the shareable device.

14. The apparatus of claim 13, further comprising:
a comparison module included in the master device to compare the first and second codes.

15. The apparatus of claim 13, wherein the first memory is a one-time programmable memory.

16. A system, comprising:
a content server including an application associated with a master code included in a master device and a selected number of shareable codes to enable concurrent execution of the application on a master device and a number of shareable devices up to the selected number; and
a wireless interface coupled to the content server.

17. The system of claim 16, further comprising:
the master device to receive the application and the master code from the content server.

18. The system of claim 16, wherein the master device comprises a wireless communication device.

19. A method, comprising:
issuing a master license associated with an application to a master device; and
issuing a plurality of shareable licenses associated with the application to the master device.

20. The method of claim 19, further including:
conducting a subscription transaction associated with the master license and the application prior to issuing the master license.

21. The method of claim 19, further including:
conducting a second subscription transaction associated with the master license and the application prior to issuing a second plurality of shareable licenses associated with the application to the master device.

22. The method of claim 19, wherein issuing the plurality of shareable licenses associated with the application to the master device includes:
enabling the master device to control execution of the application on a number of shareable devices corresponding to the plurality of shareable licenses.

23. An apparatus comprising:
a memory to store an application, a master license, and a plurality of shareable licenses;
a processor, coupled to the memory, to execute the application; and
a wireless interface, coupled to the processor, to transmit the application and a shareable license included in the plurality of shareable licenses to a wireless apparatus.

24. The apparatus of claim 23, further comprising:
a module to limit the plurality of shareable licenses to a selected number.

25. The apparatus of claim 23, wherein the application comprises a second code, further comprising:
a one-time programmable memory to store a first code; and
a comparison module to compare the first code with the second code.

26. The apparatus of claim 25, wherein the processor is to execute the application only if the first code matches the second code.

27. The apparatus of claim 23, further comprising:
a one-time programmable memory to store a code.

28. The apparatus of claim 27, wherein the code comprises a gate-keeper code.

29. The apparatus of claim 23, wherein the application comprises a game.

30. An apparatus comprising:
a wireless interface;
a control module, coupled to the wireless interface, to receive an authorization from a wireless apparatus; and
a processor, coupled to the control module, to execute an application if and only if the authorization is received by the control module.

31. The apparatus of claim 30, wherein the authorization comprises a shareable license.

32. The apparatus of claim 30, wherein the authorization comprises a shareable license emanating from the wireless apparatus, wherein the wireless apparatus includes a master license.

33. The apparatus of claim 32, wherein the shareable license is one of a selected number of shareable licenses allocated to the wireless apparatus.

34. The apparatus of claim 30, wherein the application comprises a game.

35. A server comprising:
a wireless interface to communicate with a wireless apparatus;
a control module, coupled to the wireless interface, to evaluate a request from the wireless apparatus and to transmit an application to the wireless apparatus, along with a master license and at least one shareable licenses.

36. The server of claim 35, wherein the application comprises a multi-player game.

37. The server of claim 35, wherein the control module is to transmit a plurality of shareable licenses, including the at least one shareable license, to the wireless apparatus.
